(19) United States
(12) Patent Application Publication
(10) Pub. No.: US 2025/0176457 A1
(43) Pub. Date: Jun. 5, 2025

(54) MULTISPECTRAL IMAGING INTEGRATED SYSTEM AND DEVICE AND USING METHOD THEREOF

(71) Applicant: Yuanrui SONG, Binzhou (CN)

(72) Inventor: Yaqi LI, Zibo (CN)

(73) Assignee: Yuanrui Song, Binzhou (CN)

(21) Appl. No.: 19/035,757

(22) Filed: Jan. 23, 2025

(30) Foreign Application Priority Data
Nov. 27, 2023 (CN) 202311596104.9

(51) Int. Cl. A01C 7/08; A01C 5/06; A01C 21/00

(52) U.S. Cl. CPC A01C 7/085; A01C 5/064; A01C 21/00

(57) ABSTRACT

The present invention discloses a seed broadcasting method and a full-width uniform seeding method and device, and relates to the technical field of seeding. The technical solution lies in that the method includes the steps: constructing an elongated seed broadcasting shell structure, where a seed discharge opening is provided in the lower portion of a seed broadcasting shell, and seed inlets are formed in two ends in a length direction; connecting an outlet end of a seeder to a seed conveying pipeline, charging an airflow into the seed conveying pipeline, and pushing seeds into the seed inlets in two ends of the seed broadcasting shell with the help of flow of the airflow; and enabling the seeds entering the seed broadcasting shell to be distributed in the length direction of the seed broadcasting shell, fall down, and then to be discharged from the seed discharge opening.

### CROSS-REFERENCE TO RELATED APPLICATIONS

The application claims priority to Chinese patent application No. 2024115714883, filed on Nov. 6, 2024, the entire contents of which are incorporated herein by reference.

### TECHNICAL FIELD

The present invention relates to the technical field of seeding, and in particular to a seed broadcasting method and a full-width uniform seeding method and device.

### BACKGROUND

With the development of an agricultural technology, at present, seeding patterns mainly include two patterns of drill seeding and broadcast seeding, and according to different crops, there are seeding effects of a corresponding preferred seeding pattern. As far as seeding of wheat especially in saline-alkali soil in a coastal area is concerned, it has been proved by experiments that it is more appropriate to use broadcast seeding as a seeding pattern for this type of land.

For the broadcast seeding pattern which is different from seeding equipment adopting drill seeding, broadcast seeding has higher requirements for laying uniformity of wheat seeds, needs to satisfy the requirement of uniformly dispersing the wheat seeds in a larger seeding range, and has higher difficulty in mechanized operations. For example, a technology disclosed in the previous application CN114303534A, namely DEEP FERTILIZATION SECONDARY COMPACTING FULL-WIDTH UNIFORM SOWING MACHINE AND SOWING METHOD, and a technology disclosed in CN114503815A, namely SECONDARY COMPACTING FULL-WIDTH PRECISION SOWER AND SOWING METHOD, which are seeding equipment of broadcast seeding. However, after the actual use in recent years, it is found that there are certain shortcomings in the above-mentioned application and the above-mentioned technology.

As first-generation equipment, a deep fertilization secondary compacting full-width uniform seeding machine adopts an operation mode of combining a precision seeding component with a broadcast seeding component. The precision seeding component uses a seeding structure similar to a drill seeder to realize seeding in strip areas, and combined with the broadcast seeding component arranged between precision seeding components, seed broadcast seeding on the ground between the adjacent strip areas is realized. Although this pattern can meet the requirement for overall broadcast seeding to the ground, there is a large difference in the intensity of seeding between a precision seeding area and a broadcast seeding area, and some seeds are difficult to emerge, resulting in seed waste.

Different from the former namely the deep fertilization secondary compacting full-width uniform seeding machine, the secondary compacting full-width precision seeder as later improved equipment adopts two sets of precision seeders in staggered arrangement instead to achieve the function of full-width uniform seeding. Although large-width uniform seeding can also be achieved, the seeding component of the equipment still adopts a form of seeding based on drill seeding, and the situation of uneven seed density still exists, which also leads to waste of seeds and failure in achieving a more ideal broadcast seeding effect.

### SUMMARY

In response to one of defects of the prior art, the present invention provides a seed broadcasting method and a full-width uniform seeding method and device to solve the technical problem of how to realize full-width uniform seeding during seeding.

In order to realize the above-mentioned purposes, the present invention adopts the following technical solutions. A seed broadcasting method, including the steps:
S1, constructing an elongated seed broadcasting shell structure, where a seed discharge opening is provided in the lower portion of a seed broadcasting shell, seed inlets are formed in two ends in a length direction, a running direction during seed broadcasting is taken as a, and a length direction of the seed broadcasting shell is taken as b, with a and b not being parallel;
S2, connecting an outlet end of a seeder to seed conveying pipelines, charging an airflow into the seed conveying pipelines, pushing seeds into the seed inlets in two ends of the seed broadcasting shell with the help of flow of the airflow, and enabling the seeds to enter the seed broadcasting shell from the seed inlets of the seed broadcasting shell; and
S3, enabling the seeds entering the seed broadcasting shell to be distributed in the length direction of the seed broadcasting shell, to fall down, and then to be discharged from the seed discharge opening.

Preferably, the step S3 includes:
S301, setting several seed drop positions inside the seed broadcasting shell, where the seed drop positions are distributed in the length direction of the seed broadcasting shell; and
S302, enabling the seeds entering the seed broadcasting shell to move in the length direction of the seed broadcasting shell, after the seeds move to the seed drop positions, changing a movement direction of the seeds from the seed drop positions, and enabling the seeds to move towards the direction of the seed discharge opening.

Preferably, in the step S301, the seed drop positions are set uniformly in an area from two ends to the middle of the seed broadcasting shell, and
the step S3 further includes:
S303, guiding the seeds blown out of the seed drop positions, and guiding the seeds towards the seed discharge opening, where a method for guiding the seeds includes: providing several flow guide members in the area from the seed drop positions to the middle position of the seed broadcasting shell, the flow guide members being distributed in the length direction of the seed broadcasting shell, and the flow guide members being provided in wave-shaped distribution; and
taking the maximum diameters of the seeds as d1 and the width of the flow guide members as d2, and satisfying that d2 is less than or equal to 3d1.

A full-width uniform seeding method includes the steps:
A1, performing rotary tillage on the ground;
A2, performing seed broadcasting by the above-mentioned seed broadcasting method; and
A3, performing soil covering and compacting on the area subjected to seed broadcasting.

Preferably, a method for performing rotary tillage on the ground in the step A1 specifically includes:
A101, taking a seeding direction as a which is a forward direction, and performing a first rotary tillage operation in the direction a, where a rotation direction of rotary tillage knives during the first rotary tillage operation is a direction in which the rotary tillage knives rotate towards the direction a from top to bottom; and
A102, performing a second rotary tillage operation after the first rotary tillage operation, where the rotation direction of the rotary tillage knives during the second rotary tillage operation is opposite to the rotation direction of the rotary tillage knives during the first rotary tillage operation.

Preferably, in the step A3, the performing soil covering and compacting on the area subjected to seed broadcasting specifically includes:
A301, during a process of the second rotary tillage operation, stirring soil subjected to rotary tillage to a position above the seed broadcasting shell by using the rotary tillage knives;
A302, conveying flying soil stirred in A301 to a position behind the seed broadcasting shell, and enabling the flying soil to fall down to the ground; and
A303, compacting the ground after the soil drops in A302.

A seeding device applied to the above-mentioned seeding method includes:
a rotary tillage mechanism capable of performing rotary tillage on the ground and including:
a first rotary tillage unit including a first rotary tillage shaft, first rotary tillage knife sets being provided on the first rotary tillage shaft,
and a second rotary tillage unit being provided on the rear side of the first rotary tillage unit and provided adjacent to the first rotary tillage unit, where the second rotary tillage unit includes a second rotary tillage shaft, second rotary tillage knife sets being provided on the second rotary tillage shaft, and the rotation direction of the second rotary tillage shaft being opposite to that of the first rotary tillage shaft;
a seed broadcasting mechanism which is applied to the above-mentioned seed broadcasting method and includes:
the seed broadcasting shell being of an elongated structure, the inner portion of the seed broadcasting shell being a cavity, the seed discharge opening being formed in the lower portion of the seed broadcasting shell, and seeds being capable of be discharged from the seed discharge opening,
and seed broadcasting tube sets including several seed broadcasting tubes provided inside the seed broadcasting shell,
an inlet end of each seed broadcasting tube being in communication with a seed supplying mechanism through the seed conveying pipelines, the seed supplying mechanism being an airflow conveying type mechanism, outlet ends of the seed broadcasting tubes in the seed broadcasting tube sets being distributed above the seed discharge opening of the seed broadcasting shell; and
a soil covering mechanism arranged on the rear side of the second rotary tillage unit, where a covering-soil conveying unit can convey soil turned up by the second rotary tillage unit to a rear part.

Compared with the prior art, the present invention has the following beneficial effects: the seed broadcasting method adopting the present solution can realize full-width uniform seeding of crop seeds, and has significant advantages of improving photosynthetic efficiency, water utilization efficiency, pest and disease resistance, and overall grain yield and quality through full-width uniform seeding in a planting area.

On this basis, the present solution also proposes a corresponding seeding method and seeding device in conjunction with the seed broadcasting method, which can further ensure the implementation of the seed broadcasting method, and can obtain an excellent full-width uniform seeding effect.

### BRIEF DESCRIPTION OF THE DRAWINGS

FIG. 1 shows a schematic diagram I of an overall structure of an embodiment of the present application;

FIG. 2 shows a schematic diagram II of an overall structure of an embodiment of the present application;

FIG. 3 shows a schematic diagram III of an overall structure of an embodiment of the present application;

FIG. 4 shows a schematic diagram IV of an overall structure of an embodiment of the present application;

FIG. 5 shows a structural schematic diagram of a first rotary tillage unit of an embodiment of the present application;

FIG. 6 shows a structural schematic diagram of a second rotary tillage unit of an embodiment of the present application;

FIG. 7 shows a structural schematic diagram I of a seed broadcasting mechanism of an embodiment of the present application;

FIG. 8 shows a structural schematic diagram II of a seed broadcasting mechanism of an embodiment of the present application;

FIG. 9 shows a partial enlargement view of A in FIG. 8;

FIG. 10 shows an elevation view of an embodiment of the present application;

FIG. 11 shows an A-A sectional view of FIG. 10;

FIG. 12 shows a schematic diagram I of the state of a hidden seed broadcasting shell of an embodiment of the present application;

FIG. 13 shows a schematic diagram II of the state of a hidden seed broadcasting shell of an embodiment of the present application;

FIG. 14 shows a main view of the state of a hidden seed broadcasting shell of an embodiment of the present application;

FIG. 15 shows a structural schematic diagram I of flow guide plates and flow guide bars of an embodiment of the present application;

FIG. 16 shows a structural schematic diagram II of flow guide plates and flow guide bars of an embodiment of the present application;

FIG. 17 shows a structural schematic diagram of a conveyor belt of an embodiment of the present application;

FIG. 18 shows a schematic diagram of the state of a hidden conveyor belt of an embodiment of the present application;

FIG. 19 shows a comparative view of a root system scan of an embodiment of the present application;

FIG. 20 shows a comparative view of wheat canopy reflectance of an embodiment of the present application;

FIG. 21 shows an infrared thermogram of uniform seeding of an embodiment of the present application; and

FIG. 22 shows an infrared thermogram of drill seeding of an embodiment of the present application.

### IN THE FIGURES

100, seed supplying mechanism; 200, rack;
1, rotary tillage mechanism; 11, first rotary tillage unit; 111, first rotary tillage shaft; 112, first rotary tillage knife; 12, second rotary tillage unit; 121, second rotary tillage shaft; 122, second rotary tillage knife; 13, rotary tillage linkage unit;
2, seed broadcasting mechanism; 21, seed broadcasting shell; 211, seed discharge opening; 22, seed broadcasting tube set; 221, seed broadcasting tube; 23, flow guide assembly; 231, flow guide plate; 232, flow guide bar;
3, soil covering mechanism; 31, conveyor shaft; 311, conveyor shaft bar; 312, clamping slot; 32, conveyor belt; 321, belt body; 322, clamping strip; 4, compacting mechanism; 41, compacting roller; 42, compacting frame; 43, compacting adjustment assembly; 44, clearing member.

### DETAILED DESCRIPTION OF THE EMBODIMENTS

The technical solutions in the embodiments of the present application will be clearly and completely described below in conjunction with the accompanying drawings in the embodiments of the present invention, and it is clear that the embodiments described are only a part of the embodiments of the present invention but not all of the embodiments. Based on the embodiments of the present invention, all other embodiments obtained by those of ordinary skill in the art without making creative efforts fall within the scope of protection of the present invention.

The present application provides the following technical solution:
a seed broadcasting method includes the steps:
S1, constructing an elongated seed broadcasting shell structure, where a seed discharge opening is provided in the lower portion of a seed broadcasting shell, seed inlets are formed in two ends in a length direction, a running direction during seed broadcasting is taken as a, and a length direction of the seed broadcasting shell is taken as b, with a and b being perpendicular, in other words, the seed broadcasting direction a is taken as a longitudinal direction, and the length direction of the seed broadcasting shell is taken as a transverse direction;
S2, connecting an outlet end of a seeder to seed conveying pipelines, charging an airflow into the seed conveying pipelines, pushing seeds into the seed inlets in two ends of the seed broadcasting shell with the help of flow of the airflow, and enabling the seeds to enter the seed broadcasting shell from the seed inlets of the seed broadcasting shell; and
S3, enabling the seeds entering the seed broadcasting shell to be distributed in the length direction of the seed broadcasting shell, to fall down, and then to be discharged from the seed discharge opening. The step S3 specifically includes the following steps:
S301, setting several seed drop positions inside the seed broadcasting shell, where the seed drop positions are distributed in the length direction of the seed broadcasting shell, and the seed drop positions are set uniformly in an area from two ends to the middle of the seed broadcasting shell;
S302, enabling the seeds entering the seed broadcasting shell to move in the length direction of the seed broadcasting shell, after the seeds move to the seed drop positions, changing a movement direction of the seeds from the seed drop positions, and enabling the seeds to move towards the direction of the seed discharge opening; and
S303, guiding the seeds blown out of the seed drop positions, and guiding the seeds towards the seed discharge opening, where a method for guiding the seeds includes: providing several flow guide members in the area from the seed drop positions to the middle position of the seed broadcasting shell, the flow guide members being distributed in the length direction of the seed broadcasting shell, and the flow guide members being provided in wave-shaped distribution; and taking the maximum diameters of the seeds as d1 and the width of the flow guide members as d2, and satisfying that d2 is approximately equal to 1.5d1.

In the present solution, the airflow is used as power for conveying the seeds, and the seed broadcasting shell perpendicular to the seeding direction is used as a seed conveying channel, the seeds are discharged out of the seed broadcasting shell to fall down through the seed drop positions uniformly distributed in the seed broadcasting shell, which is more conducive to the dispersal of the seeds. On this basis, seeds flying out of the seed drop positions are guided by the flow guide members, and the seeds are directly blocked by the flow guide members to fall down, such that the problem of unbalanced seed drop points due to gradual weakening of the airflow can be solved, the seeds are dispersed more uniformly, and the effect of uniform seeding can be maintained throughout the entire range of seed broadcasting covered by the seed broadcasting shell.

On the basis of the embodiments, the present solution further provides a full-width uniform seeding method, including the steps:
A1, performing rotary tillage on the ground, where the rotary tillage includes the following steps:
A101, taking a seeding direction as a which is a forward direction, and performing a first rotary tillage operation in the direction a, where a rotation direction of rotary tillage knives during the first rotary tillage operation is a direction in which the rotary tillage knives rotate towards the direction a from top to bottom; and
A102, performing a second rotary tillage operation after the first rotary tillage operation, where the rotation direction of the rotary tillage knives during the second rotary tillage operation is opposite to the rotation direction of the rotary tillage knives during the first rotary tillage operation.
A2, performing seed broadcasting by the seed broadcasting method in the above-mentioned solution;
A3, performing soil covering and compacting on the area subjected to seed broadcasting, where a specific method of performing soil covering and compacting includes:
A301, during a process of the second rotary tillage operation, stirring soil subjected to rotary tillage to a position above the seed broadcasting shell by using the rotary tillage knives;
A302, conveying flying soil stirred in A301 to a position behind the seed broadcasting shell, and enabling the flying soil to fall down to the ground; and
A303, compacting the ground after the soil drops in A302.

Through the method of the present solution, during rotary tillage, the soil turned up by the second rotary tillage operation is thrown to a position above the seed broadcasting shell by the rotary tillage knives and then conveyed to the rear part, and therefore, the process of seed dropping in the step A2 cannot be influenced. In other words, there is less contact between soil particles that are thrown during the rotary tillage operation and the seeds falling from the seed broadcasting shell, and the seeds can fall directly onto the ground under the action of the above-mentioned seed broadcasting method. This ensures the uniform seeding effect. As the seeding operation proceeds, the soil that is thrown to the rear part by the rotary tillage knives can cover the seeds that fall to the ground, thereby completing soil covering, and then performing compaction.

Through test, in the method, the full-width uniform seeding pattern is adopted for seeding, is different from conventional drill seeding, and has significant advantages of improving photosynthetic efficiency, water utilization efficiency, pest and disease resistance, and overall grain yield and quality. Despite higher initial investment and high management complexity of uniform seeding, long-term benefits and environmental benefits are significantly better.

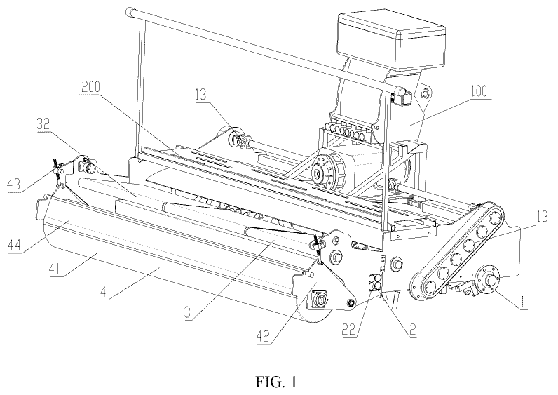

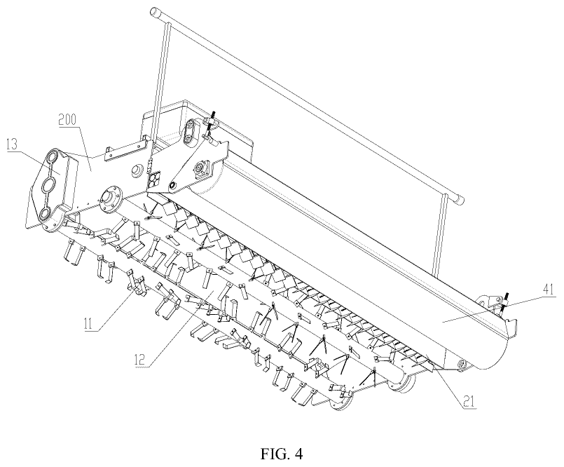

On the basis of the embodiments, referring to FIG. 1 to FIG. 4, the present solution further provides a seeding device, and the seeding device is applied to the above-mentioned seed broadcasting method and the seeding method. The running direction of seeding is taken as the forward direction, namely the direction a is taken as the forward direction, and the device includes a rotary tillage mechanism 1, a seed broadcasting mechanism 2, a soil covering mechanism 3, and a compacting mechanism 4, which are arranged in sequence from the front to the rear. The device can be towed by traction equipment such as a tractor when working. The mechanisms are all arranged on a rack 200, and the rotary tillage mechanism 1 includes a first rotary tillage unit 11 and a second rotary tillage unit 12 which can perform rotary tillage on the ground. The soil covering mechanism 3 is arranged on the rear side of the second rotary tillage unit 12. The seed broadcasting mechanism 2 is located below the soil covering mechanism 3. The soil covering mechanism 3 can convey the soil turned up by the second rotary tillage unit 12 to the rear part. The compacting mechanism 4 is arranged on the rear side of the soil covering mechanism 3, the compacting mechanism 4 includes a compacting roller 41, and the soil can be compacted by the compacting roller 41. A seed supplying mechanism 100 is further provided on the rack 200, and the seed supplying mechanism 100 can select the existing seeder for use. The seed broadcasting mechanism 2 is applied to the above-mentioned seed broadcasting method, and the seeding device is entirely applied to the above-mentioned seeding method.

On the basis of the above-mentioned embodiments, the first rotary tillage unit 11 in the rotary tillage mechanism 1 includes a first rotary tillage shaft 111, where first rotary tillage knife sets are provided on the first rotary tillage shaft 111. The second rotary tillage unit 12 is arranged on the rear side of the first rotary tillage unit 11, and arranged adjacent to the first rotary tillage unit 11, where the second rotary tillage unit 12 includes a second rotary tillage shaft 121, and second rotary tillage knife sets are provided on the second rotary tillage shaft 121. The first rotary tillage shaft 111 and the second rotary tillage shaft 121 are both rotationally connected to the rack 200. The first rotary tillage shaft 111 and the second rotary tillage shaft 121 are linked through a rotary tillage linkage unit 13, a power input end of the rotary tillage linkage unit 13 is linked with a power source, and a power output end of the rotary tillage linkage unit 13 drives the first rotary tillage shaft 111 and the second rotary tillage shaft 121 to rotate. The power source can select an output power source of a traction vehicle, or is configured with an independent power source.

The specific linkage structure form of the rotary tillage linkage unit 13 can adopt the existing technical solution, such as gear transmission, belt transmission, chain transmission, etc., preferably the chain transmission. The rotary tillage linkage unit 13 only needs to satisfy the requirement of driving the first rotary tillage shaft 111 to rotate forwards and the second rotary tillage shaft 121 to rotate backwards when working. In order to facilitate clearer description, a rolling direction of wheels of the traction vehicle when moving towards the direction a, namely, moving forwards, is taken as al, in the process of rotary tillage operations, the rotation direction of the first rotary tillage shaft 111 is in the same as the al, and the rotation direction of the second rotary tillage shaft 121 is opposite to the al. In this driving direction, the first rotary tillage shaft 111 rotates forwards, so that the first rotary tillage unit 11 stirs and raises the soil backwards; and the second rotary tillage shaft 121 rotates backwards to throw the soil stirred by the first rotary tillage unit 11 obliquely backwards and upwards, so that the soil can pass over the seed broadcasting mechanism 2 and then fall onto the soil covering mechanism 3.

Through the structure of the present solution, rotary tillage operations are performed through the first rotary tillage unit 11 and the second rotary tillage unit 12 to crush the land, and then the soil raised by the second rotary tillage unit 12 is conveyed to the rear part through the soil covering mechanism 3. Through the structure, the seed broadcasting mechanism 2 is arranged in a covering range of the soil covering mechanism 3, the soil is guided and conveyed through the soil covering mechanism 3, and the soil raised during the rotary tillage operations keeps away from the seeds broadcast by the seed broadcasting mechanism 2, so as to effectively solve the problem that the soil thrown during the rotary tillage operations affects seed drop positions, to better ensure that the seeds can fall down in the seed falling range designed by the device, and to ensure seeding effects of full-width uniform seeding.

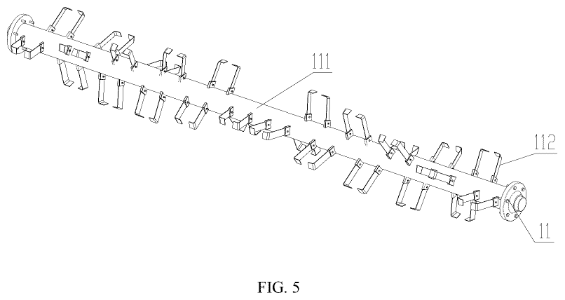

On the basis of the above-mentioned embodiments, referring to FIG. 5, each first rotary tillage knife set includes the first rotary tillage knives 112 arranged around the first rotary tillage shaft 111, where one end of each first rotary tillage knife 112 is fixedly connected to the first rotary tillage shaft 111, and the other end of each first rotary tillage knife extends towards a direction being away from the first rotary tillage shaft 111. The end of each first rotary tillage knife 112 that is away from the first rotary tillage shaft 111 is of a bending structure, that is to say, each first rotary tillage knife 112 presents a structure similar to a figure “7”. The first rotary tillage knives 112 of the first rotary tillage knife sets are spirally distributed on the circumferential side of the first rotary tillage shaft 111.

Through the solution, by means of the first rotary tillage knives 112 having the bending structure, crushing effects on the soil can be improved during rotation of the first rotary tillage shaft 111, so as to achieve basic rotary tillage operations. The first rotary tillage knives 112 are spirally distributed, and then the first rotary tillage knives 112 in the whole first rotary tillage knife sets are in contact with the ground respectively corresponding to different rotation angles of the first rotary tillage shaft 111, so as to effectively reduce burden to equipment.

On the basis of the above-mentioned embodiments, each first rotary tillage knife set includes several rotary tillage knife subsets, and the rotary tillage knife subsets are spirally distributed. Each rotary tillage knife subset includes two first rotary tillage knives 112, and end bending structures of the two first rotary tillage knives 112 in the same rotary tillage knife subset are opposite in bending directions; and as shown in FIG. 5, the bending directions being opposite here include two conditions, one of which as shown in FIG. 5 of the present solution lies in that bending portions of the two first rotary tillage knives 112 in the same rotary tillage knife subset are oppositely arranged. The other solution can also be contrary to the present solution, that is to say, the bending portions of the two first rotary tillage knives 112 in the same rotary tillage knife subset are arranged away from each other. Both of these patterns are feasible, but in actual use, because of different conditions of ground surfaces, according to experiments, especially when applied to the land state where saline-alkali soil hardening is more serious, the present solution adopted where the bending portions of the two first rotary tillage knives 112 in the same rotary tillage knife subset are oppositely arranged has a better effect of crushing the soil, and the first rotary tillage knives have a longer service life.

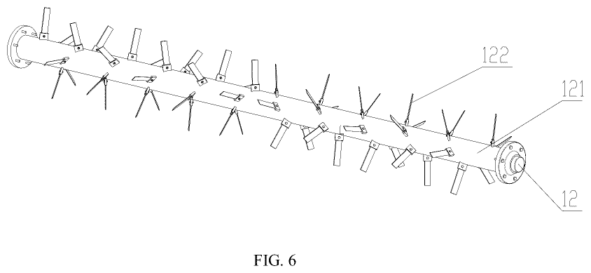

On the basis of the above-mentioned embodiments, referring to FIG. 6, each second rotary tillage knife set includes the second rotary tillage knives 122 arranged around the second rotary tillage shaft 121, where one end of each second rotary tillage knife 122 is fixedly connected to the second rotary tillage shaft 121, and the other end of each second rotary tillage knife extends towards a direction being away from the second rotary tillage shaft 121. Unlike the first rotary tillage knives 112, each of the second rotary tillage knives 122 has a blade of a straight plate-shaped structure, and the second rotary tillage knives 122 of the second rotary tillage knife sets are spirally distributed on the circumferential side of the second rotary tillage shaft 121.

The second rotary tillage unit 12, as a subsequent working unit of the first rotary tillage unit 11, can perform secondary crushing on the soil crushed by the first rotary tillage unit 11. Due to structural limitations of the equipment, it is the most reasonable that the first rotary tillage shaft 111 and the second rotary tillage shaft 121 are designed to have the same length. Therefore, unlike a pattern of providing blades of the first rotary tillage knives 112, a pattern of providing the second rotary tillage knives 122 in a straight plate shape on the second rotary tillage shaft 121 is adopted, so that the second rotary tillage unit 12 and the first rotary tillage unit 11 can generate different rotary tillage crushing effects in the form of different spacings and different screw pitches on shaft bars having the same length, and thus further enhancing the rotary tillage effects of the first rotary tillage unit 11.

On the basis of the above-mentioned embodiments, a knife body of each second rotary tillage knife 122 is obliquely arranged. Through the knife bodies which are obliquely arranged, the second rotary tillage unit 12 has another function other than soil crushing, that is to say, the effect of stirring and guiding the soil. As mentioned above, the soil covering mechanism 3 is also arranged in the present solution, by means of the second rotary tillage knives 122 which are obliquely arranged, under the action of the rotation of the second rotary tillage shaft 121, the second rotary tillage knives 122 can throw the soil to a position above the soil covering mechanism 3, and the soil is further conveyed backwards through the soil covering mechanism 3.

On the basis of the above-mentioned embodiments, the second rotary tillage knives 122 are obliquely arranged in multiple patterns, which only need to meet the requirements of the above-mentioned solution. The present solution proposes a specific arrangement pattern satisfying the following two points.

I, A middle line of each second rotary tillage knife 122 in the length direction is taken as L, and an extension line of the line L may intersect with an axis of the second rotary tillage shaft 121, that is to say, the second rotary tillage knives 122 can extend in a radial direction of the second rotary tillage shaft 121.

II, An included angle between an extended surface of the knife body of each second rotary tillage knife 122 and an axis of the second rotary tillage shaft 121 is 30 degrees to 60 degrees, preferably 45 degrees. It can also be understood here that, taking any of the second rotary tillage knives 122 as a reference, the knife body of each second rotary tillage knife 122 is perpendicularly projected towards the second rotary tillage shaft 121, because each second rotary tillage knife 122 is in a blade shape, the projection is regarded as a straight line, and for included angles formed between the straight line and the axis of each second rotary tillage shaft 121, an acute angle is 45 degrees,
that is, the state shown in FIG. 6. Through the arrangement form of the second rotary tillage knives 122 in the solution, both the soil crushing effect and the soil conveying effect can be taken into account, which is the optimal structure form.

On the basis of the above-mentioned embodiments, two first rotary tillage knife sets are arranged on the first rotary tillage shaft 111 and are arranged in a mirror symmetry pattern by using a middle cross section of the first rotary tillage shaft 111 as a symmetrical plane. Similar to the pattern of the first rotary tillage unit 11, two second rotary tillage knife sets are provided on the second rotary tillage shaft 121 and are arranged in a mirror symmetry pattern by using a middle cross section of the second rotary tillage shaft 121 as a symmetrical plane.

In other words, the two first rotary tillage knife sets on the first rotary tillage shaft 111 present opposite spiral directions, and likewise, the two second rotary tillage knife sets on the second rotary tillage shaft 121 also have opposite bolt directions. Through such an arrangement form, the force on shaft bars of the rotary tillage shafts during operations can be well dispersed, and the force on the shaft bars is dispersed to two halves of each shaft bar in a balanced pattern, which can increase the stability of the two rotary tillage shafts during the operations and prolong the service life of the equipment.

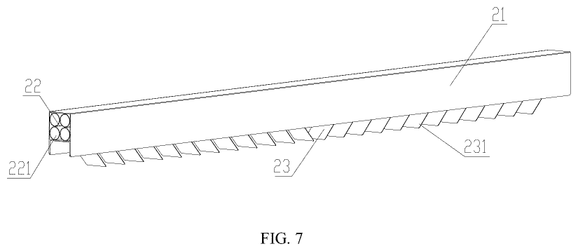

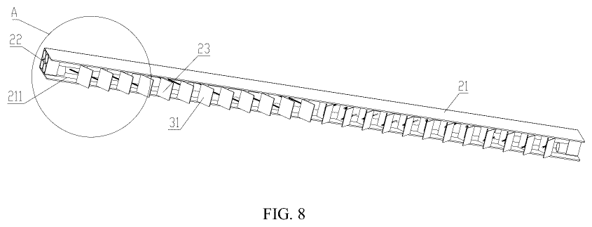

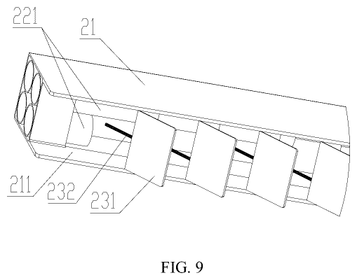

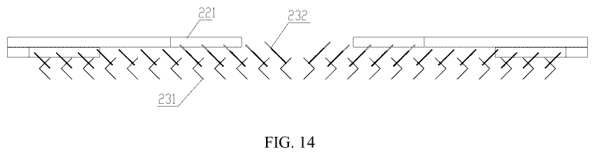

On the basis of the above-mentioned embodiments, the seed broadcasting mechanism 2 in the present solution is applied to the above-mentioned seed broadcasting method, referring to FIG. 7 to FIG. 14, the seed broadcasting mechanism 2 includes an elongated seed broadcasting shell 21, the inner portion of the seed broadcasting shell 21 is a cavity, the lower portion of the seed broadcasting shell 21 is an opening which is a seed discharge opening 211, and seeds fall down from and are discharged from the seed discharge opening 211 during seeding. Seed broadcasting tube sets 22 provided in the seed broadcasting shell 21, and each seed broadcasting tube set 22 includes several seed broadcasting tubes 221. An inlet end of each seed broadcasting tube 221 is in communication with a seed supplying mechanism 100 through seed conveying pipelines, the seed supplying mechanism 100 includes a seeder, an outlet end of the seeder is connected to each seed conveying pipeline, and each seed conveying pipeline is connected to the corresponding seed broadcasting tube 221. An airflow is charged into the seed conveying pipelines, and the seeds are conveyed in an airflow conveying pattern. The seeds are blown into the seed broadcasting tubes 221 through the airflow, pass through tube bodies of the seed broadcasting tubes 221 under the action of the airflow, and drop out of the outlet ends of the seed broadcasting tubes 221. The outlet ends of the seed broadcasting tubes 221 in the seed broadcasting tube sets 22 are uniformly distributed above the seed discharge opening 211 of the seed broadcasting shell 21.

Through the structure of the present solution, a whole air channel structure is formed through the seed broadcasting shell 21, besides, an independent seed conveying pipeline is provided corresponding to each seed broadcasting tube 221, the seed conveying pipelines are in communication with the seeder, and the seeds are conveyed into each seed broadcasting tube 221 by means of the airflow. Combined with the characteristics of airflow conveying, the seeds are blown out of the outlet ends of the seed broadcasting tubes 221 to be dispersed parabolically, and fall out of the seed discharge opening 211 to the ground. Because the outlet ends of the seed broadcasting tubes 221 are distributed at different positions, large-area uniform broadcast seeding can be achieved. There will not be a problem similar to that the seeds are intensively discharged in a local seeding area by a drill seeding instrument but there is no seed around a seeding area.

On the basis of the above-mentioned embodiments, the seed broadcasting tubes 221 in the seed broadcasting tube sets 22 are of different lengths, the outlet ends of the seed broadcasting tubes 221 are formed in a horizontal direction, and the inlet ends of the seed broadcasting tubes 221 extend to one end of the seed broadcasting shell 21 in the length direction. A running direction of the whole device during seeding is taken as a longitudinal direction, and the length direction of the seed broadcasting tubes 221 is a transverse direction.

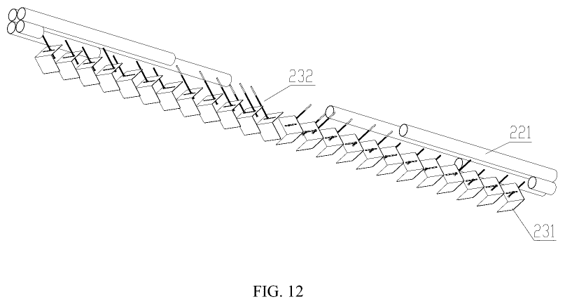

Different from a conventional seeding structure, the seeding direction adopted by the seed broadcasting tubes 221 in the present solution is a horizontal direction. As shown in FIG. 12, when the seeds are discharged from the seed broadcasting tubes 221, the movement direction is the transverse direction. In conventional seeding equipment, the discharge direction of the seed conveying pipelines is the direction where the seeds fall down vertically, or the seed discharge direction is basically consistent with the seeding direction. In the present solution, a form of discharging the seeds by the airflow is adopted, such that the seeds are blown by the airflow to be discharged out of the seed broadcasting tubes 221. When the seeds are separated from tube openings of the seed broadcasting tubes 221, parabolic movement is performed. Since it is impossible that the seeds are completely consistent in the weight, this form is more conducive to dispersion of the seeds. In this way, combined with the distributed structure formed by the outlet ends of the plurality of seed broadcasting tubes 221 in the seed broadcasting shell 21, the uniform broadcast seeding effect can be better achieved.

On the basis of the above-mentioned embodiments, two seed broadcasting tube sets 22 are arranged in the seed broadcasting shell 21 and are arranged in a mirror symmetry pattern; the inlet ends of the seed broadcasting tubes 221 in the two seed broadcasting tube sets 22 are located in two ends of the seed broadcasting shell 21 in the length direction; and the outlet ends are provided toward a middle direction of the seed broadcasting shell 21.

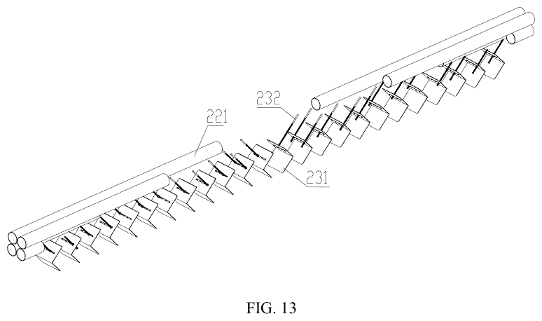

Specifically, each seed broadcasting tube set 22 includes four seed broadcasting tubes 221; the seed broadcasting tubes 221 in the same seed broadcasting tube set 22 are arranged in a rectangular array, that is to say, the four seed broadcasting tubes 221 are distributed in positions presenting a Chinese character “Tian”, and the positions of the outlet ends of the seed broadcasting tubes 221 are distributed from the end to a middle position of the seed broadcasting shell 21. Referring to FIG. 12 and FIG. 13, the lengths of the seed broadcasting tubes 221 increase in sequence, with the lower two seed broadcasting tubes 221 being shorter and the two seed broadcasting tubes 221 at the upper portion being longer. With such structure, the outlet ends of the seed broadcasting tubes 221 present a structure form of being gradually distributed from the end to the middle position of the seed broadcasting shell 21, and contain the horizontal and vertical distribution of the Chinese character “Tian”. The seeds can be blown out of the outlet end of each seed broadcasting tube 221 by the airflow, and the seeds are dispersed to fall down while being blown to be cast out of the seed broadcasting tubes 221, and fall out of the seed discharge opening 211 to the ground, the effect is closer to manual sprinkling, and dispersion is excellent. By combining the seeding of 8 seed broadcasting tubes 221 in two sets, the entire length area of the seed broadcasting shell 21 can be completely covered.

The entire length of the seed broadcasting shell 21 used in the present solution is 270 cm, and the number of the seed broadcasting tubes 221 can be adaptively increased or decreased according to the specifications of actual sown products.

On the basis of the above-mentioned embodiments, a flow guide assembly 23 is also provided at the seed discharge opening 211 of the seed broadcasting shell 21, and the seeds discharged from the outlet ends of the seed broadcasting tubes 221 can be guided through the flow guide assembly 23, so that seeding dispersion and seeding uniformity are further improved.

The flow guide assembly 23 includes several flow guide plates 231, and the flow guide plates 231 are uniformly distributed in a linear array in the length direction of the seed broadcasting shell 21; and a plate body of each flow guide plate 231 is provided with an inclined portion, and the inclined portion is of an inclined plate structure. As mentioned above, the present solution adopts a structure form in which the outlet ends of the seed broadcasting tubes 221 are horizontally arranged. In addition to the seed throwing effect relative to the outlet ends of the seed broadcasting tubes 221, which is formed by conveying the seeds through the airflow, the additional flow guide plates 231 serve as a guiding structure of the airflow and the seeds, which can be more conducive to the uniform dispersal of the seeds.

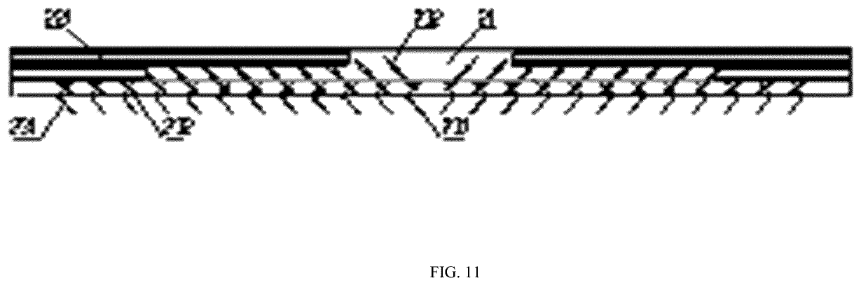

On the basis of the above-mentioned embodiments, referring to FIG. 11, each flow guide plate 231 is a bent plate body, including an upper bent plate and a lower bent plate. The upper end of each upper bent plate is obliquely arranged towards the middle direction of the seed broadcasting shell 21, and the lower end of each upper bent plate is obliquely arranged towards the end direction of the seed broadcasting shell 21; and each lower bent plate is fixedly connected to the lower edge of the corresponding upper bent plate, and the lower edge of each lower bent plate is obliquely arranged towards the middle direction of the seed broadcasting shell 21. Each flow guide plate 231 is in the shape of “<”, and the flow guide plates 231 are symmetrically arranged at the middle of the seed broadcasting shell 21. Taking the direction of FIG. 11 as a reference, the flow guide plates 231 at the middle of the seed broadcasting shell 21 to the left are in the shape of “<”, and the flow guide plates 231 at the middle to the right are in the shape of “>”. The direction in which the airflow is blown out is toward the protrusive position of the flow guide plates 231. After the seeds fly out of the seed broadcasting tubes 221, the seeds that fall on the upper bent plates of the flow guide plates 231 will reversely bounce or slide towards the end direction of the seed broadcasting shell 21 in the inclined direction of the bent plates. Relatively speaking, in order to prevent the seeds that fly out to more upward positions from flying too far, the flow guide plates 231 can guide the seeds in the opposite direction. The seeds flying out of positions below the lower bent plates of the flow guide plates 231 indicate that throwing force is already weak, so that there is no need to impede the seeds.

It should be noted here that the upper edges of the upper bent plates of the flow guide plates 231 are located below the tube openings of the lower seed broadcasting tubes 221 but do not extend to a pipeline extension line of the seed broadcasting tubes 221. Neither the airflow nor the seeds are separated from the seed broadcasting tubes 221 in a cylindrical direction, but will be dispersed after being separated from the outlet ends, so that as long as the positions of the upper bent plates of the flow guide plates 231 satisfy that the upper bent plates are located below the extension line of the tube openings of the seed broadcasting tubes 221.

On the basis of the above-mentioned embodiments, the flow guide assembly 23 is also provided with flow guide bar sets which are also arranged at the seed discharge opening 211, and one flow guide bar set is provided corresponding to each seed broadcasting tube 221. Each flow guide bar set includes several flow guide bars 232, and the flow guide bars 232 are arranged on one side of the outlet end of the corresponding seed broadcasting tube 221 that is towards the middle of the seed broadcasting shell 21. Each flow guide bar 232 is a bar body which is obliquely arranged, the upper end of the bar body of each flow guide bar 232 is inclined towards the end direction of the seed broadcasting shell 21, that is to say, inclined towards the direction of the outlet end of the corresponding seed broadcasting tube 221, and the lower end of the bar body of each flow guide bar 232 is inclined towards the middle direction of the seed broadcasting shell 21. Taking the direction in FIG. 11 as a reference, the upper ends of the flow guide bars 232 located at the left half of the seed broadcasting shell 21 are inclined towards the left, and the lower ends are inclined to the right. On the contrary, the upper ends of the flow guide bars 232 located in the right half of the seed broadcasting shell 21 are inclined towards the right, and the lower ends are inclined towards the left.

On the basis of combining the flow guide plates 231, the additional flow guide bars 232 are used as an intercepting structure for the seeds. After the seeds are conveyed out of the seed broadcasting tubes 221 by the airflow, the seeds close to the outlet ends are at a relatively high speed, and the seeds far away from the outlet ends are less affected by the airflow. Therefore, the flow guide bars 232 are arranged on the flight path of the seeds, the seeds can be blocked by the bar bodies of the flow guide bars, and some seeds can be intercepted in the position closer to the outlet ends of the seed broadcasting tubes 221, so that the seeds can be dispersed more uniformly in the area between the outlet ends of the seed broadcasting tubes 221 and the position where the seeds fly farthest.

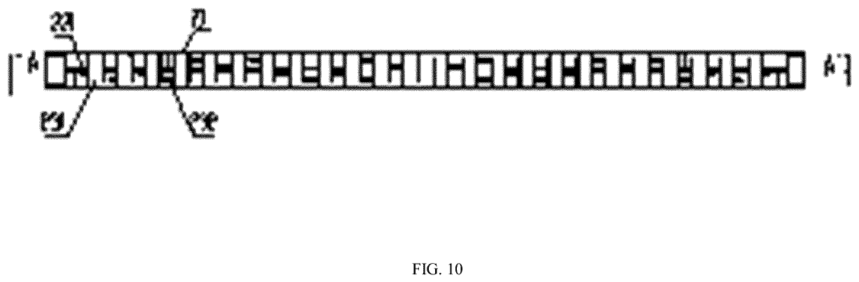

On the basis of the above-mentioned embodiments, the flow guide bars 232 in the same flow guide bar set are distributed in a linear array in the length direction of the seed broadcasting shell 21. Besides, the flow guide bars 232 in the same flow guide bar set are arranged in a staggered distribution pattern in the linear direction. Referring to FIG. 10, it can be seen from the direction in FIG. 10 that the flow guide bars 232 are provided in the outlet direction of each seed broadcasting tube 221, and the flow guide bars 232 present a layout form of up-down staggered arrangement. The flow guide bars 232 have the effect of intercepting some seeds rather than blocking all the seeds, so that the bar bodies adopt such a setting form that the outside diameter of the bar bodies is slightly larger than the outside diameter of seed particles. The maximum diameter of the seeds is taken as d1, and the diameter of the flow guide bars 232 is taken as d2, which satisfy that d2 is less than or equal to 1.5d1 and d2 is greater than or equal to d1. Through the such setting form of the present solution, it can be satisfied that the flow guide bars 232 block part of the seeds, while the seeds that are not blocked fall down normally according to their parabolic path.

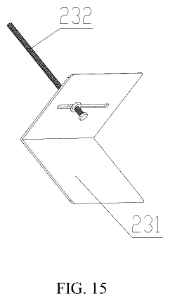

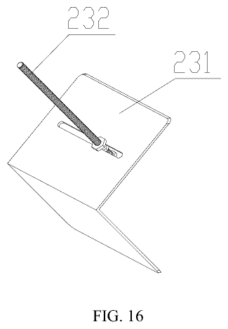

On the basis of the above-mentioned embodiments, referring to FIG. 15 and FIG. 16, for case of machining and adjustment, the flow guide bars 232 are movably connected to the flow guide plates 231, and the flow guide bars 232 can move towards or away from the corresponding seed broadcasting tubes 221.

Multiple specific achievement forms can be adopted, for example, the flow guide bars 232 adopt a retractable bar structure. The present solution adopts the form that the flow guide bars 232 are screws, which has three effects. First, with the help of a screw structure, the flow guide bars 232 and the flow guide plates 231 can be in threaded connection, and the length of the flow guide bars 232 towards the direction of the seed broadcasting tubes 221 can be adjusted directly by twisting, to achieve telescopic adjustment. Second, a threaded structure is convenient to process, and compared with its own telescopic structure, the bar bodies directly adopting the threaded structure are lower in manufacturing cost; and when the structure is applied to a seeder, the simple screw structure is more durable. Third, the flow guide bars 232 have threads, and after the airflow is blown to the bar bodies of the flow guide bars 232, compared with smooth bar bodies, the airflow more easily enters threaded slots in the bar bodies of the flow guide bars 232, thereby driving the seeds to come into contact with the flow guide bars 232. If a smooth bar body structure is adopted, after the airflow is blown onto the bar bodies of the flow guide bars 232, a layer of fluid cover will be formed on a surface layer in contact with the bar bodies, which easily makes the seeds go around the flow guide bars 32 under the guidance of the airflow, rather than colliding with the bar bodies of the flow guide bars 232.

On the basis of the above-mentioned embodiments, referring to FIG. 11, connection positions of the upper bent plates and the lower bent plates of the flow guide plates 231 are flush with the lower edge of the seed discharge opening 211. The airflow for conveying the seeds will spread when being discharged from discharge openings of the outlet ends of the seed broadcasting tubes 221, the seed broadcasting shell 21 itself also has the effect of airflow guidance, the seed discharge opening 211 is located below, the upper bent plates are located in the seed broadcasting shell 21, and thus helping to play a role in the uniform dispersal of the seeds, which has been explained in the above-mentioned content, and will not be repeated here. The lower bent plates have the effect of making the seeds in a low falling angle fall smoothly, so that arranging the lower bent plates on the outside of the seed broadcasting shell 21 is more conducive to spreading of the airflow and more conducive to the dispersal of the seeds.

Referring to FIG. 15 and FIG. 16, the flow guide bars 232 are movably connected to the upper bent plates; the length direction of the seed broadcasting shell 21 is the longitudinal direction, the horizontal width direction of the seed broadcasting shell 21 is the transverse direction, and a chute in a transverse direction is provided in the plate body of each upper bent plate; and the flow guide bars 231 can slide along the chutes in the upper bent plates.

The present solution adopts the following structure form that two nuts are in threaded connection with the bar body of each flow guide bar 232, the two nuts are respectively located on two sides of each upper bent plate, and the flow guide bars 232 slide in the chutes of the upper bent plates. In addition to the structure, other structure forms can also be adopted, as long as the flow guide bars 232 can move laterally and stretch out and draw back relative to the upper bent plates.

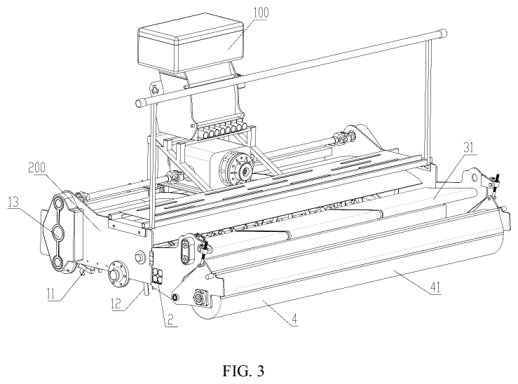

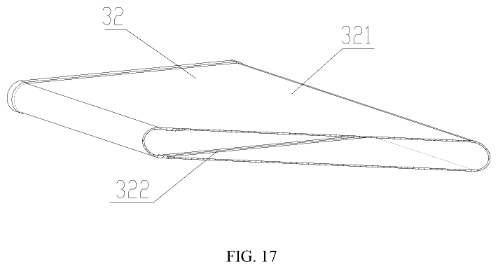

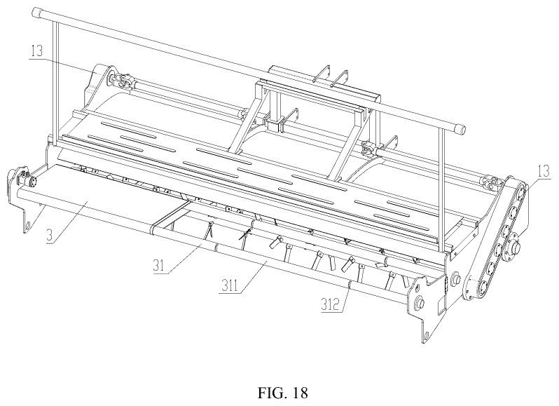

On the basis of the above-mentioned embodiments, referring to FIG. 1, FIG. 3, FIG. 17 and FIG. 18, the soil covering mechanism 3 is of a conveyor belt type conveying structure; and a conveyor inlet end of the soil covering mechanism 3 is arranged close to the second rotary tillage unit 12, and a conveyor outlet end of the soil covering mechanism is arranged in a pattern of extending towards the rear compacting mechanism 4.

The soil covering mechanism 3 includes conveyor shafts 31 and a conveyor belt 32. The two conveyor shafts 31 are arranged, where at least one of the conveyor shafts 31 is a driving rotation shaft, and the other conveyor shaft is a driven rotation shaft. The conveyor belt 32 is sleeved outside the conveyor shafts 31, and can rotate along with the conveyor shafts 31; and the conveyor belt 32 is obliquely arranged, and one side of the conveyor belt that is close to the second rotary tillage unit 12 is a low level side. The seed broadcasting mechanism 2 is arranged in an area below the conveyor belt 32. A soil covering structure is arranged on a discharge side of the conveyor belt 32, and the conveyor belt 32 can convey the soil to the front side of the compacting mechanism 4, so that a soil covering operation on the seeds can be achieved; and then the compacting mechanism 4 is used for compacting, and the seeds will not be affected by the rotary tillage work during the whole process.

On the basis of the above-mentioned embodiments, the overall width value of the device is larger because of the consideration of having a larger working area when seeding as much as possible. In this case, if the integrated conveyor shafts 31 are adopted, it is easy to cause the problem of shaft bar fracture, or it is necessary to make the conveyor shafts 31 from a high-strength material at a large cost, and this type of material is often heavy, which will increase the load of equipment. In addition, in the case of a large width, there is another problem, in the case of long-time working, the conveyor belt 32 is easy to run off, causing it to skew on the conveyor shafts, thus affecting the working.

In view of these two problems, the conveyor shafts 31 of the present solution adopt a splicing structure form, and each conveyor shaft 31 is spliced by multiple sections of conveyor shaft bars 311, which is more conducive to the force dispersion of the overall conveyor shafts 31, and the manufacturing cost can also be effectively reduced. As for skewing of the conveyor belt 32, the conveyor belt 32 in the present solution is spliced by multiple belt bodies 321, as shown in FIG. 3, the conveyor belt 32 is wholly manufactured by splicing three belt bodies 321, and the two edges of the central belt body 321 are sleeved in inner rings of the two belt bodies 321 on the sides. On this basis, referring to FIG. 17, a clamping strip 322 is arranged inside each belt body 321, and each clamping strip 322 forms an annular strip-shaped convex structure in the corresponding belt body 321, a clamping slot 312 is formed in the corresponding clamping strip 322 on each conveyor shaft 31, and each clamping strip 322 is in clamping connection with the inner portion of the corresponding clamping slot 312. Through this form, the problem of skewing and deviation of the conveyor belt 32 can be effectively avoided.

On the basis of the above-mentioned embodiments, an annular notch is provided at the connection position of two adjacent conveyor shaft bars 311. After two adjacent conveyor shaft bars 311 are connected, an annular notch position is fitted into the clamping slot 312. This pattern takes into account the convenience of processing and mounting, while meeting equipment requirements.

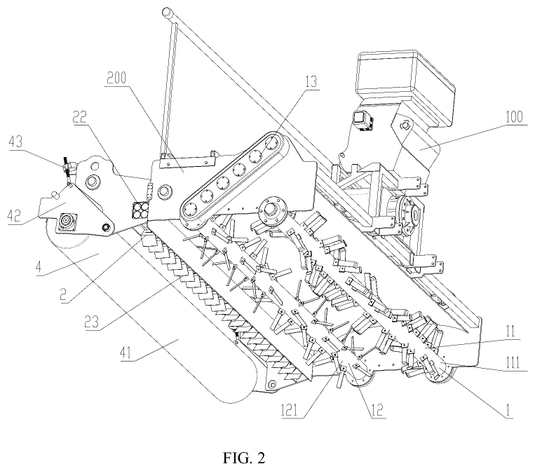

On the basis of the above-mentioned embodiments, referring to FIG. 2, a compacting framework 4 also includes a compacting frame 42, a compacting roller 41 is rotationally connected to the compacting frame 42, and one side of the compacting frame 42 is rotationally connected to the front side of the rack 200. A compacting adjustment assembly 43 is provided between the compacting frame 42 and the rack 200. The compacting frame 42 can be driven by the compacting adjustment assembly 43 to rotate relative to the rack 200, so as to achieve adjustment of a relative angle between the compacting frame 42 and the rack 200.

Through the mechanism, adjustment of the compacting strength of the compacting mechanism 4 can be achieved, the lower position to which the compacting frame 42 drives the compacting roller 41, the stronger the compacting strength is, and on the contrary, the weaker the compacting strength is.

In a conventional seeding solution, compaction is usually performed entirely by deadweight of the compacting roller, and the working height of the compacting roller cannot be adjusted according to the needs of use. According to the structure of the present solution, appropriate compacting strength can be obtained by changing the position of the compacting frame 42. When large-strength compaction is needed, support force borne by the compacting roller in the present solution is from the power of the whole equipment, that is transmitted by the rack 200, so that larger-strength compaction can be performed.

On the basis of the embodiments, the present solution provides a specific structure form of the compacting adjustment assembly 43. The compacting adjustment assembly 43 includes a compacting adjustment bar which is a screw, and one end of the bar body of the compacting adjustment bar is rotationally connected to the compacting frame 42. The front side of the rack 200 is rotationally connected to a compacting adjustment seat, an adjustment sleeve is rotationally connected to the interior of the compacting adjustment seat, and the adjustment sleeve is threaded connection with the compacting adjustment bar.

When adjustment needs to be performed, only a compacting sleeve needs to be rotated, then the compacting adjustment bar is driven by the threaded structure to move up and down relative to the adjustment sleeve, thus driving the compacting frame 42 to rotate relative to the rack 200.

On the basis of the above-mentioned embodiments, the compacting mechanism 4 further includes a clearing member 44, the clearing member 44 is wholly of a scraper structure, the upper portion is in hanging connection to the compacting frame 42, and the lower portion is fitted with the outer surface of the compacting roller 41. Considering that the surface of the compacting roller 41 will be attached with soil after the compacting roller works for a long time, the clearing member 44 is provided to scrape the soil off along with the rotation of the compacting roller 41.

On the basis of the above-mentioned embodiments, a rotating shaft is arranged at the upper portion of the clearing member 44, a U-shaped slot is provided in the compacting frame 42 corresponding to the rotating shaft, and the rotating shaft is in clamping connection with the inner portion of the U-shaped slot. Through the structure, the clearing member 44 is in hanging connection to the U-shaped slot of the compacting frame 42 by means of the deadweight. If there are extremely firm soil clods attached to the compacting roller 41 or stones embedded into the compacting roller 41, the clearing member 44 will be slightly jacked up without damaging the relatively thin lower edge of the clearing member 44.

On the basis of the above-mentioned embodiments, the compacting adjustment assembly 43 further includes an adjustment driving member which is fixedly connected to the compacting adjustment seat, the adjustment driving member is a motor, a motor shaft of the motor is linked to the adjustment sleeve, and the adjustment sleeve can be driven to rotate. Through the structure, the compacting frame 42 can be adjusted in an electric control pattern.

On the basis of the above-mentioned embodiments, the compacting adjustment assembly 43 further includes an inductor which is arranged at the lower edge portion of the clearing member 44, an inducing end of the inductor is arranged downwards, and the inductor is a pressure sensor such as a deformation resistor. The inductor can be specifically arranged at the middle or two ends of the lower edge portion of the clearing member 44. The inductor is electrically connected to a control module to form a feedback loop, and the control module is electrically connected to the adjustment driving member to form a control loop. The soil will be attached to the outer surface of the compacting roller 41 during compacting, so that compacting strength or soil moisture can both affect the attachment intensity of the soil on the outer surface of the compacting roller 41. When the clearing member 44 is used for clearing, the inductor can feed back the adhesion of the soil in contact with the inductor, and if the fed back adhesion is too large, the adjustment driving member drives the compacting frame 42 to life up slightly. On the contrary, the compacting frame 42 can also be driven to slightly decrease so as to obtain proper compacting strength.

The seeding device and the seeding method in the present solution can be suitable for seeding of multiple different crops, and are mainly suitable for seeding of wheat. The present solution is different from a traditional drill seeding technology, and full-width uniform seeding of wheat is achieved. The following is comparative experiment demonstration of wheat growth after seeding with full-width uniform seeding (referred to as uniform seeding) in the present solution and conventional drill seeding (referred to as drill seeding).

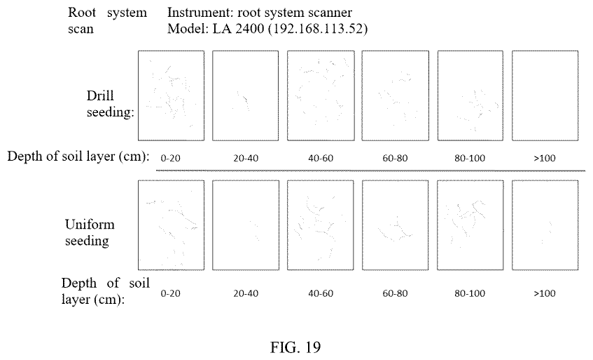

Referring to FIG. 19, a root system scanner of a model LA 2400 is used for scanning root systems of wheat growing after drill seeding and root systems of wheat growing after uniform seeding, respectively. It can be seen that at a depth of 0-100 cm, root system coverage is achieved in two seeding patterns, after a depth of more than 100 cm, the wheat has extremely few root system distribution by the drill seeding, while the wheat still has root system distribution by uniform seeding. In addition, in the depth range of 0-100 cm, the root system distribution of the wheat growing by the uniform seeding is more uniform than that of the wheat growing by the drill seeding, which is more conducive to the growth of the wheat. For the root systems of the wheat, root length usually reflects the ability of plants to expand in the soil, which facilitates improvement of absorption of water and nutrients. Larger root lengths mean that the root systems can come into contact with more soil volume and absorb more water and nutrients, improving the drought resistance of crops.

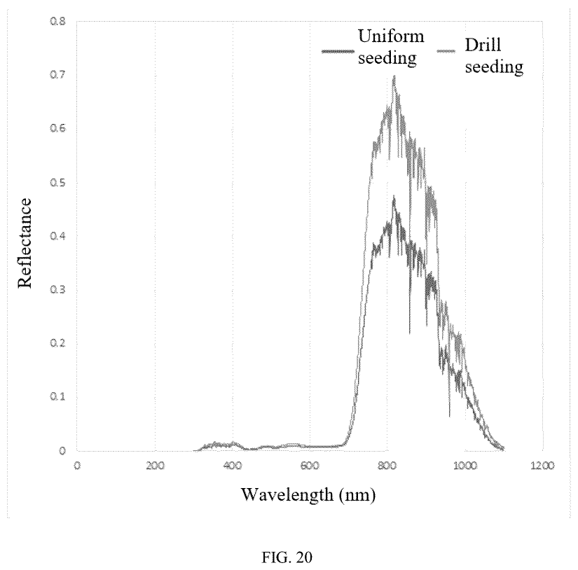

Referring to FIG. 20, differences between drill seeding and uniform seeding will lead to differences in canopy structures of the wheat, and the differences in the canopy structures will lead to changes in spectral reflectance. The characteristics of the canopy structures of the wheat can be compared under different seeding patterns through reflectance data. The reflectance of the wheat in the range of 300-1100 nm is measured by a ground object spectrometer (model: ATP9100), and the characteristics of the canopy structures of the wheat under different seeding patterns are compared. Drill seeding will lead to significant row gaps in the wheat canopies, where the soil is usually exposed. Under the uniform seeding pattern, the wheat canopies are more uniform to cover and less soil is exposed. This can reduce the overall reflectance, lower reflectance represents that there is more chlorophyll and healthy cell structures in leaves, meaning that more radiation energy is absorbed by vegetation for photosynthesis, which facilitates improvement of the growth rate and biomass accumulation of the wheat. In addition, plants growing in the uniform seeding have uniform spacings, which facilitates maintaining of soil moisture and reduction of evaporation, reduces growth differences due to uneven density, and ultimately facilitates improvement of grain yield and quality of the wheat.

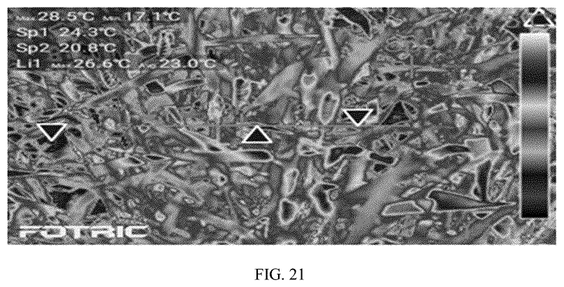

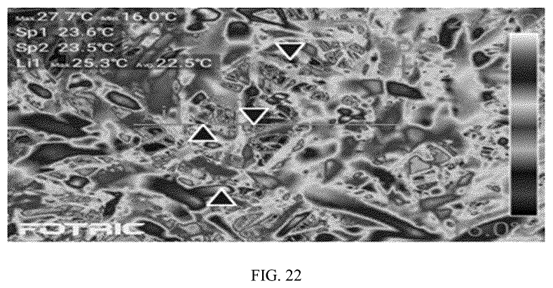

The drill seeding and the uniform seeding will lead to a difference in canopy density, to generate different temperature distribution, and a thermal imaging map can display consistency in wheat growth during wheat evaluation. A hand-held thermal imager (FOTRIC 288) is used for shooting, and temperature distribution and wheat growth conditions are analyzed. FIG. 21 shows wheat growing by the uniform seeding, with dense and uniform arrangement of wheat plants, which reduces high-temperature areas with soil bared. Therefore, the temperature distribution is more uniform, and less high-temperature areas exist. The vegetation coverage is high, and the overall temperature is more consistent, showing more stable temperature characteristics. FIG. 22 shows the wheat growing by the drill seeding, the wheat growing by the drill seeding has a large row gap, resulting in significant temperature differences, and especially higher temperature shown in places where the soil is exposed. The temperature distribution is relatively complex, and more high-temperature areas exist.

TABLE 1
Influence of seeding patterns on grain yield and constituent factors thereof

| | | Grain | Spike number | Grain | |
|---|---|---|---|---|---|
| | Seeding | yield | (10 thousand of | number per | 1000-grain |
| Year | pattern | (kg · km⁻²) | spikes hm⁻²) | spike | weight (g) |
| 2022-2023 | Full-width | 7822.70 ± | 718.52 ± | 27.82 ± | 34.35 ± |
| | uniform | 159.95aA | 13.35aA | 0.18bB | 0.09bB |
| | seeding | | | | |
| | Conventional | 6609.67 ± | 488.89 ± | 29.29 ± | 40.40 ± |
| | drill | 53.39bB | 7.35bB | 0.38aA | 0.15aA |
| | seeding | | | | |
| 2023-2024 | Full-width | 7697.32 ± | 707.41 ± | 27.56 ± | 34.47 ± |
| | uniform | 75.73aA | 16.14aA | 0.34bB | 0.16bB |
| | seeding | | | | |
| | Conventional | 6483.88 ± | 480.56 ± | 28.9 ± | 40.54 ± |
| | drill | 75.09bB | 10.02bB | 0.18aA | 0.15aA |
| | seeding | | | | |
| Significance | | | | | |
| (P-value) | | | | | |
| Seeding | | <0.001 | <0.001 | 0.003 | <0.001 |
| pattern (P) | | | | | |
| Year (Y) | | 0.304 | 0.371 | 0.302 | 0.220 |
| Seeding | | 0.412 | 0.895 | 0.840 | 0.998 |
| pattern * | | | | | |
| year (P*Y) | | | | | |

As can be seen from Table 1, for different seeding patterns in the same year, the grain yield and the spike number in the full-width uniform seeding are the highest, and compared with those in conventional drill seeding, the grain yield and the spike number were significantly increased by 18.35% and 46.97% from 2022 to 2023, respectively, and significantly increased by 18.71% and 47.21% from 2023 to 2024, respectively. The results of the two years both showed that the grain number per spike and 1000-grain weight were the lowest in full-width uniform seeding, and compared with those in the conventional drill seeding, the grain number per spike and the 1000-grain weight were significantly decreased by 5.02% and 14.98% from 2022 to 2023, respectively, and significantly decreased by 4.64% and 14.97% from 2023 to 2024, respectively.

TABLE 2
Influence of seeding patterns on photosynthetic effective radiation interception
rate, interception amount and transmissivity of wheat canopies during blooming
period, and radiation use efficiency of wheat canopies during growth period

| | | | | | Radiation |
|---|---|---|---|---|---|
| | | | Interception | | use |
| | Seeding | Interception | amount | | efficiency |
| Year | pattern | rate (%) | (MJ m⁻²) | Transmissivity | (%) |
| 2022-2023 | Full-width | 94.99 ± | 8.62 ± | 1.26 ± | 0.78 ± |
| | uniform | 0.04aA | 0.00aA | 0.03bB | 0.02aA |
| | seeding | | | | |
| | Conventional | 91.25 ± | 8.28 ± | 4.91 ± | 0.53 ± |
| | drill | 0.14bB | 0.01bB | 0.04aA | 0.00bB |
| | seeding | | | | |
| 2023-2024 | Full-width | 95.18 ± | 8.50 ± | 1.07 ± | 0.72 ± |
| | uniform | 0.07aA | 0.01aA | 0.07bB | 0.01aA |
| | seeding | | | | |
| | Conventional | 91.42 ± | 8.16 ± | 4.35 ± | 0.50 ± |
| | drill | 0.20bB | 0.02bB | 0.07aA | 0.00bB |
| | seeding | | | | |
| Significance | | | | | |
| (P-value) | | | | | |
| Seeding | | <0.001 | <0.001 | <0.001 | <0.001 |
| pattern (P) | | | | | |
| Year (Y) | | 0.174 | <0.001 | <0.001 | 0.004 |
| Seeding | | 0.955 | 0.851 | 0.016 | 0.359 |
| pattern * | | | | | |
| year (P*Y) | | | | | |

As can be seen from Table 2, for different seeding patterns in the same year, the photosynthetic effective radiation interception rate, the interception amount and the radiation use efficiency of winter wheat canopies in the full-width uniform seeding are the highest, and compared with those in conventional drill seeding, the photosynthetic effective radiation interception rate, the interception amount and the radiation use efficiency were significantly increased by 4.10%, 4.11% and 47.17% from 2022 to 2023, respectively, and significantly increased by 4.11%, 4.11% and 44.00% from 2023 to 2024, respectively. The results of the two years being consistent showed that the transmissivity was the lowest in full-width uniform seeding, and compared with that in the conventional drill seeding, the transmissivity of two growth seasons was significantly decreased by 74.26% and 75.39% from 2022 to 2023, and from 2023 to 2024, respectively.

In the description of the present application and embodiments thereof, it should be noted that, the orientations or positional relationships indicated by the terms “top”, “bottom”, “height”, etc. are based on those shown in the accompanying drawings, intended only for the convenience of describing the present application and for simplifying the description, and not intended to indicate or imply that the referred device or element must be provided with a particular orientation or constructed and operated with a particular orientation, therefore not allowed to be construed as a limitation of the present application.

In the present application and the embodiments thereof, unless otherwise expressly specified and defined, the terms “arranged”, “mounted”, “attached”, “connected”, “fixed”, etc. should be understood in a broad sense, for example, a connection may be a fixed connection, a detachable connection, or an integral connection; it may be a mechanical connection or an electrical connection, or may be communication; it may be a direct connection or an indirect connection via an intermediate medium; and it may be a connection between two elements or an interaction between two elements. For those of ordinary skill in the art, the specific meanings of the above terms in the present application can be understood on a case-by-case basis.

In the present application and the embodiments thereof, unless otherwise expressly specified and defined, a first feature being “above” or “below” a second feature may include not only direct contact between the first and second features, but also include indirect contact between the first and second features via another feature between them. Furthermore, the first feature being “above”, “over” and “on” the second feature includes the first feature being directly above and diagonally above the second feature, or simply means that the first feature is higher in level than the second feature. Furthermore, the first feature being “below”, “under” and “beneath” the second feature includes the first feature being directly below and diagonally below the second feature, or simply means that the first feature is lower in level than the second feature.

The disclosure above provides many different embodiments or examples to implement different structures of the present application. To simplify the disclosure of the present application, components and settings for specific examples are described above. Certainly, they are examples only and are not intended to limit the present application. In addition, the present application may repeat reference numbers and/or reference letters in different examples for the purpose of simplification and clarity, but this repetition itself does not indicate the relationship between various embodiments and/or settings discussed. In addition, the present application provides examples of various specific processes and materials, but those of ordinary skill in the art may be aware of the application of other processes and/or the use of other materials.

Although the preferred embodiments of the present application have been described, those skill in the art benefiting from the underlying inventive concept can make additional modifications and variations to these embodiments. Therefore, the appended claims are intended to be construed as encompassing the embodiments and all the modifications and variations falling in the scope of the present application.

Apparently, various modifications and variations to the present application can be made by those skill in this art without departing from the spirit and scope of the present application. Thereby, the present application intends to encompass all such modifications and variations within the scope of the claims of the present application and its equivalents.

What is claimed is:

1. A seed broadcasting method, comprising the steps:
S1, constructing an elongated seed broadcasting shell structure, wherein a seed discharge opening is provided in the lower portion of a seed broadcasting shell, seed inlets are formed in two ends in a length direction, a running direction during seed broadcasting is taken as a, and a length direction of the seed broadcasting shell is taken as b, with a and b not being parallel;
S2, connecting an outlet end of a seeder to seed conveying pipelines, charging an airflow into the seed conveying pipelines, pushing seeds into the seed inlets in two ends of the seed broadcasting shell with the help of flow of the airflow, and enabling the seeds to enter the seed broadcasting shell from the seed inlets of the seed broadcasting shell; and
S3, enabling the seeds entering the seed broadcasting shell to be distributed in the length direction of the seed broadcasting shell, to fall down, and then to be discharged from the seed discharge opening.

2. The seed broadcasting method according to claim 1, wherein the step S3 comprises:
S301, setting several seed drop positions inside the seed broadcasting shell, wherein the seed drop positions are distributed in the length direction of the seed broadcasting shell; and
S302, enabling the seeds entering the seed broadcasting shell to move in the length direction of the seed broadcasting shell, after the seeds move to the seed drop positions, changing a movement direction of the seeds from the seed drop positions, and enabling the seeds to move towards the direction of the seed discharge opening.

3. The seed broadcasting method according to claim 2, wherein in the step S301, the seed drop positions are set uniformly in an area from two ends to the middle of the seed broadcasting shell, and
the step S3 further comprises:
S303, guiding the seeds blown out of the seed drop positions, and guiding the seeds towards the seed discharge opening, wherein a method for guiding the seeds comprises: providing several flow guide members in the area from the seed drop positions to the middle position of the seed broadcasting shell, the flow guide members being distributed in the length direction of the seed broadcasting shell, and the flow guide members being provided in wave-shaped distribution; and
taking the maximum diameters of the seeds as d1 and the width of the flow guide members as d2, and satisfying that d2 is less than or equal to 3d1.

4. A full-width uniform seeding method, comprising the steps:
A1, performing rotary tillage on the ground;
A2, performing seed broadcasting by the seed broadcasting method according to claim 1; and
A3, performing soil covering and compacting on the area subjected to seed broadcasting.

5. The full-width uniform seeding method according to claim 4, wherein the step of performing rotary tillage on the ground in step A1 specifically comprises:
A101, taking a seeding direction as a which is a forward direction, and performing a first rotary tillage operation in the direction a, wherein a rotation direction of rotary tillage knives during the first rotary tillage operation is a direction in which the rotary tillage knives rotate towards the direction a from top to bottom; and
A102, performing a second rotary tillage operation after the first rotary tillage operation, wherein the rotation direction of the rotary tillage knives during the second rotary tillage operation is opposite to the rotation direction of the rotary tillage knives during the first rotary tillage operation.

6. The full-width uniform seeding method according to claim 5, wherein in the step A3, the performing soil covering and compacting on the area subjected to seed broadcasting specifically comprises:
A301, during a process of the second rotary tillage operation, stirring soil subjected to rotary tillage to a position above the seed broadcasting shell by using the rotary tillage knives;
A302, conveying flying soil stirred in A301 to a position behind the seed broadcasting shell, and enabling the flying soil to fall down to the ground; and
A303, compacting the ground after the soil drops in A302.

7. A seeding device, comprising:
a rotary tillage mechanism capable of performing rotary tillage on the ground and applied to the seeding method according to claim 4, comprising:
a first rotary tillage unit comprising a first rotary tillage shaft, first rotary tillage knife sets being provided on the first rotary tillage shaft,
and a second rotary tillage unit being provided on the rear side of the first rotary tillage unit and provided adjacent to the first rotary tillage unit, wherein the second rotary tillage unit comprises a second rotary tillage shaft, second rotary tillage knife sets being provided on the second rotary tillage shaft, and the rotation direction of the second rotary tillage shaft being opposite to that of the first rotary tillage shaft;
a seed broadcasting mechanism applied to the seed broadcasting method according to claim 1, comprising:
the seed broadcasting shell being of an elongated structure, the inner portion of the seed broadcasting shell being a cavity, the seed discharge opening being formed in the lower portion of the seed broadcasting shell, and seeds being capable of be discharged from the seed discharge opening,
and seed broadcasting tube sets comprising several seed broadcasting tubes provided inside the seed broadcasting shell,
an inlet end of each seed broadcasting tube being in communication with a seed supplying mechanism through the seed conveying pipelines, the seed supplying mechanism being an airflow conveying type mechanism, outlet ends of the seed broadcasting tubes in the seed broadcasting tube sets being distributed above the seed discharge opening of the seed broadcasting shell; and
a soil covering mechanism arranged on the rear side of the second rotary tillage unit, wherein a covering-soil conveying unit can convey soil turned up by the second rotary tillage unit to a rear part.

8. The seeding device according to claim 7, wherein each first rotary tillage knife set comprises:
first rotary tillage knives arranged around the first rotary tillage shaft, wherein one end of each first rotary tillage knife is fixedly connected to the first rotary tillage shaft, and the other end of each first rotary tillage knife extends towards a direction being away from the first rotary tillage shaft;
the end of each first rotary tillage knife that is away from the first rotary tillage shaft is of a bending structure;
the first rotary tillage knives of the first rotary tillage knife sets are spirally distributed on the circumferential side of the first rotary tillage shaft;
each first rotary tillage knife set comprises:
rotary tillage knife subsets each of which comprises two first rotary tillage knives, wherein end bending structures of the two first rotary tillage knives in the same rotary tillage knife subset are opposite in bending directions; and
the rotary tillage knife subsets in the first rotary tillage knife set are spirally distributed.

9. The seeding device according to claim 8, wherein each second rotary tillage knife set comprises:
second rotary tillage knives arranged around the second rotary tillage shaft, wherein one end of each second rotary tillage knife is fixedly connected to the second rotary tillage shaft, and the other end of each second rotary tillage knife extends towards a direction being away from the second rotary tillage shaft;
a blade of each second rotary tillage knife is of a straight plate-shaped structure;
the second rotary tillage knives of the second rotary tillage knife sets are spirally distributed on the circumferential side of the second rotary tillage shaft;
a knife body of each second rotary tillage knife is obliquely arranged; an included angle between an extended surface of the knife body of each second rotary tillage knife and an axis of the second rotary tillage shaft is 30 degrees to 60 degrees;
two first rotary tillage knife sets are provided on the first rotary tillage shaft and are arranged in a mirror symmetry pattern by using a middle cross section of the first rotary tillage shaft as a symmetrical plane; and
two second rotary tillage knife sets are provided on the second rotary tillage shaft and are arranged in a mirror symmetry pattern by using a middle cross section of the second rotary tillage shaft as a symmetrical plane.

10. The seeding device according to claim 9, wherein the soil covering mechanism is of a conveyor belt type conveying structure; a conveyor inlet end of the soil covering mechanism is arranged close to the second rotary tillage unit, and a conveyor outlet end of the soil covering mechanism is arranged in a pattern of extending towards the rear part;
the soil covering mechanism comprises:
two conveyor shafts, wherein at least one of the conveyor shafts is a driving rotation shaft; and
a conveyor belt being sleeved on the outside of each conveyor shaft, and capable of rotating along with the conveyor shaft, wherein
the conveyor belt is obliquely arranged, and one side of the conveyor belt that is close to the second rotary tillage unit is a low-level side.

11. The seeding device according to claim 7, wherein the seed broadcasting tubes in the seed broadcasting tube set are of different lengths, the outlet ends of the seed broadcasting tubes are provided in a horizontal direction; the inlet ends of the seed broadcasting tubes extend to one end of the seed broadcasting shell in the length direction;
two seed broadcasting tube sets are provided in the seed broadcasting shell and are arranged in a mirror symmetry pattern; the inlet ends of the seed broadcasting tubes in the two seed broadcasting tube sets are located at two ends of the seed broadcasting shell in the length direction; the outlet ends are arranged toward a middle direction of the seed broadcasting shell;
each of the seed broadcasting tube sets comprises several seed broadcasting tubes, wherein
the seed broadcasting tubes in the same seed broadcasting tube set are arranged in a rectangular array, and the positions of the outlet ends of the seed broadcasting tubes are distributed from the end to a central position of the seed broadcasting shell;
and further comprises:
a flow guide assembly provided at the seed discharge opening to guide seeds discharged from the outlet ends of the seed broadcasting tubes, the flow guide assembly comprising:
several flow guide plates, arranged in the length direction of the seed broadcasting shell, a plate body of each flow guide plate is provided with an inclined portion, and the inclined portion is of an inclined plate structure;
flow guide bar sets, arranged at the seed discharge opening, and one flow guide bar set is provided corresponding to each seed broadcasting tube; each flow guide bar set comprises:
at least one flow guide bar arranged on one side of the outlet end of the corresponding seed broadcasting tube towards the middle of the seed broadcasting shell; and
the flow guide bar is a bar body which is obliquely arranged, the upper end of the bar body of the flow guide bar is inclined towards the end direction of the seed broadcasting shell, and the lower end of the flow guide bar is inclined towards the middle direction of the seed broadcasting shell.
